(19) United States
(12) Patent Application Publication
(10) Pub. No.: US 2002/0078162 A1
(43) Pub. Date: Jun. 20, 2002

(54) Program generation system, network system and agent system

(75) Inventor: Masaki Kimura, Tochigi-ken (JP)

Correspondence Address: GREENBLUM & BERNSTEIN, P.L.C., 1941 ROLAND CLARKE PLACE, RESTON, VA, 20191, US

(73) Assignee: I -TINK Co., Ltd., Tokyo (JP)

(21) Appl. No.: 10/013,703

(22) Filed: Dec. 13, 2001

(30) Foreign Application Priority Data
Dec. 15, 2000 (JP) P2000-382218

(51) Int. Cl. G06F 15/167

(52) U.S. Cl. 709/213; 709/227; 709/230

(57) ABSTRACT

A network system are connected a server system and a client system manipulated by a user through a network, the network system comprising: a client system which is configured to use a default program and a modified program stored in the server system in response to manipulations by the user; an interface unit which is configured to receive a request for a service in accordance with manipulations by the user; a storage unit in which are stored a default program and a plurality of command codes which are executed in response to the request for a service as input through the interface unit; a program control unit which is configured to modify the default program by the use of the command codes stored in the storage unit on the basis of the request for a service as given from the client terminal through the interface unit in order to generate a modified program, to execute the modified program, and to output the result of the execution of the modified program to the client terminal through the interface unit; and an operation unit which is configured to execute the modified program on the basis of the information as input through the interface unit and to output the result of the execution of the modified program to the client terminal through the interface unit.

### CROSS REFERENCE TO RELATED APPLICATIONS

This application is based upon and claims the benefit of priority from prior Japanese Patent Application P2000-382218 filed on Dec. 15th, 2000; the entire contents of which are incorporated by reference herein.

### BACKGROUND OF THE INVENTION

1. Field of the Invention

The present invention relates to a hybrid integrated circuit with a program generation system, a network system and an agent system.

2. Description of the Related Art

In the case of existing client-server systems, for example, when a client system is accesses to a server system for searching a desired unit of information from units of information as accumulated in the server system, a user transmits information retrieval requirements to the server system from the client terminal manipulated by a user to receive the results of searching in agreement with the information retrieval requirements from the server system.

Furthermore, in the case of existing client-server systems, the server system serves to control viable delivery of the units of information for the respective client systems in order that each unit of information is transmitted only to the client systems as registered.

Still further, in the case of existing client-server systems, a programmer has made in advance a program for enabling data communications with a client system in order that the log of the data communications is updated to recode any event as caused by a user's manipulation and so forth together with associated information about a user in a database provided within the server system.

However, in the case of existing client-server systems, it was not the case that the program to be executed within the server system is switched for the respective users, e.g., to cope with their requirements. Accordingly, in accordance with the prior art technique, it is impossible to run the program as desired by the user while the program is modified in accordance with the user activity.

### BRIEF SUMMARY OF THE INVENTION

In accordance with an aspect of the present invention, the improvement resides in a program generation system comprising: an interface unit which is configured to receive a request for a service from a client terminal through a network; a storage unit in which are stored a default program and a plurality of command codes which are executed in response to the request for a service as input through the interface unit; a control unit which is configured to modify the default program by the use of the command codes stored in the storage unit on the basis of the request for a service as given from the client terminal through the interface unit in order to generate a modified program, to execute the modified program and to output the result of the execution of the modified program to the client terminal through the interface unit.

In accordance with another aspect of the present invention, the improvement resides in a network system in which are connected a server system and a client system manipulated by a user through a network, the network system comprising: a client system which is configured to use a default program and a modified program stored in the server system in response to manipulations by the user; an interface unit which is configured to receive a request for a service in accordance with manipulations by the user; a storage unit in which are stored a default program and a plurality of command codes which are executed in response to the request for a service as input through the interface unit; a program control unit which is configured to modify the default program by the use of the command codes stored in the storage unit on the basis of the request for a service as given from the client terminal through the interface unit in order to generate a modified program, to execute the modified program, and to output the result of the execution of the modified program to the client terminal through the interface unit; and an operation unit which is configured to execute the modified program on the basis of the information as input through the interface unit and to output the result of the execution of the modified program to the client terminal through the interface unit.

In a preferred embodiment, further improvement resides in that the agent unit takes control of the program generation system in accordance with the request for a service from a user.

In a preferred embodiment, further improvement resides in that the agent unit is provided in association with the user information file.

In a preferred embodiment, further improvement resides in that the program generation system serves to modify the process of generating a modified program in accordance with a user activity history.

In a preferred embodiment, further improvement resides in that the program generation system judges whether or not the respective command codes should be run with reference to the correlation between a user activity history and the command codes provided in the storage unit.

In a preferred embodiment, further improvement resides in that the program generation system serves to calculate the stochastic variables by using the functions, judges whether or not the respective command codes should be run with reference to the stochastic variables as calculated and generate modified programs.

In accordance with a further aspect of the present invention, the improvement resides in an agent system implemented within a computer for improving usability in making use of a service provided in the Internet, the agent system comprising: a database organized for management of the history of the past activities of a user of the service; a mechanism which serves to predict a next manipulation by the user with reference to the database and perform the next manipulation in place of the user.

In a preferred embodiment, further improvement resides in that a dialog box is automatically opened to solicit input from the user whether or not the next manipulation should be performed in advance of actually performing the next manipulation.

In a preferred embodiment, further improvement resides in that the mechanism immediately performs the next manipulation as predicted in place of the user without consent of the user.

In a preferred embodiment, further improvement resides in that a dialog box is automatically opened to enable the user to cancel the next manipulation as predicted and performed by the mechanism.

In accordance with a still further aspect of the present invention, the improvement resides in an agent system implemented within a computer for searching the Internet for information, the agent system comprising: a database organized for management of the history of text data as handled by a user of the computer; a mechanism which serves to receive a search term from the user and extract information items having a correlation with the search term therefrom; and a mechanism which serves to extract, from the information items, relevant information items having a correlation with the text data as handled by the user.

In a preferred embodiment, further improvement resides in that the text data as handled by the user of the computer and registered in the database for management includes a search term which has been used by the user.

In a preferred embodiment, further improvement resides in that the text data as handled by the user of the computer and registered in the database for management includes the text data of a web page which has been browsed by the user.

In a preferred embodiment, further improvement resides in that the text data of a web page which has been browsed by the user and printed, copied or stored by the user is registered in the database with a higher importance than other web pages.

### BRIEF DESCRIPTION OF THE SEVERAL VIEWS OF THE DRAWINGS

FIG. 1 is a block diagram showing a client-server system including the server system in accordance with an embodiment of the present invention.

FIG. 2 is a flowchart showing an exemplary procedure as conducted at the server system in accordance with an embodiment of the present invention.

FIG. 3 is a flowchart showing an exemplary procedure as conducted at the server system in accordance with an embodiment of the present invention.

### DETAILED DESCRIPTION OF THE INVENTION

In the followings, an embodiment of the present invention will be described with reference to the accompanying drawings.

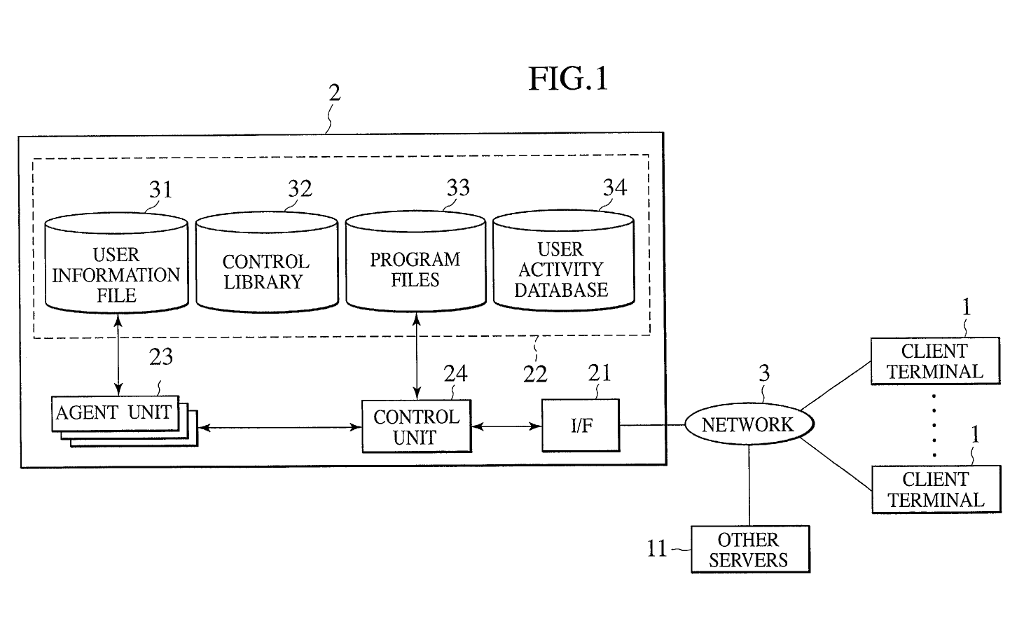

FIG. 1 is a block diagram showing a client-server system including the server system in accordance with the embodiment of the inventors of the present invention. The client-server system includes a plurality of client terminals 1 and a server 2 providing some service for the client terminals 1 in response to the requests from the client terminals 1. The server 2 and the client terminals 1 are connected to each other through a network 3. The network 3 may be, for example, a computer network open to public such as the Internet. Also, the client-server system may include another servers 11 having similar structures as the server 2.

The server 2 is provided with an interface unit 21 connected to the network 3, a storage unit 22, agent units 23 and a control unit 24 for taking control of the respective units of the server 2. The storage unit 22 serves to store a user information file 31, a control library 32, program files 33 and a user activity database 34.

The server 2 serves to exchange information units and data items with the client terminals 1 and other servers 11 through the interface unit 21 in accordance with suitable communication protocols which are implemented therein in order that information units and data items as output from the control unit 24 are transmitted to the client terminals 1 and other servers 11 and vice versa through the network 3.

The storage unit 22 is composed of, for example, a hard disk drive which is capable of storing a large amount of information and serves to store data in response to the control signals given by the control unit 24 together with a variety of units of information. There is stored in the storage unit 22 the user information file 31 containing user information items about the respective users of the client terminals 1, the control library 32 for providing control commands, the program files 33 including a variety of several programs, utilities and libraries and a user activity database 34 in which are stored logs of actions (input operations) of the respective client terminals 1. Also, a default program is prepared and stored in the storage unit 22. The default program is a base program which is modified by means of the control unit 24 as described below. The default program includes program routines such as a search engine for searching the units of information as accumulated.

The agent unit 23 serves to associate the respective client terminals 1 with the data elements stored in the storage unit 22 in order to invoke specific processes as prepared for the respective client terminals 1 as an agent for each client terminal 1. The agent unit 23 also serves to search the storage unit 22 for user information items and a user activity history for each client terminal 1 in order to determine the program routines which would likely be requested by said each client terminal 1.

Also, when a different program is created for each client terminal 1, the agent unit 23 serves to provide the control unit 24 with corresponding program preparation information.

On the other hand, the control unit 24 serves to create the modified program by modifying the default program making use of combination of the control commands stored in the control library 32 with reference to the program preparation information provided from the agent unit 23. At this time, the control unit 24 executes an usability supporting evolutionary program as stored in the program files 33 for generating modified programs with reference to the program preparation information given from the agent unit 23.

Examples of the control commands may include as described below. The control unit 24 serves to generate a modified program as an activity control program by combining the following commands as provided in the control library 32.

Namely, the control commands include the registration command (TSAVE) for registering user(s) or making amendment upon user information; a program installation command (TINST) for installing in a client terminal a program which is downloaded from the server 2 and with which a service of the server 2 becomes available in the client terminal; a run command (TRUN) for enabling a user to use the server 2; a data update command (UPD) for synchronizing data stored in the server and data stored in a terminal; a condition input command (JOKEN) for inputting conditions, i.e., the information retrieval requirement, narrowering the target condition and so forth; a condition registration command (JSAVE) for registering a condition as input with an appropriate title; a condition deletion command (JDEL) for deleting a condition; an information search command (FIND) for searching the units of information for an necessary information unit(s) which meets the condition and writing the results of searching on a search result page; a data store command (SAVE) for storing the search result page, mails, and other information in a disk storage device and so forth; a display command (DISP) for displaying the contents of the search result page, mails and so forth; a print command (PRINT) for printing the contents of the search result page, mails and so forth; an area select command (R) for designating the areas to be printed and displayed and designating the period; a print command (PRINT) for registering mail addresses and outputting data of the search result pages and mails to a printer; a mail address registration command (MSAVE) for registering mail addresses to which are transmitted the results of searching, the messages from the server and so forth; a mail send command (SND) for transmitting the contents of the mail pages to the addresses as registered; a mail reception command (REC) for receiving mails from designated addresses to the mail pages of the respective users; a data reception command (DREC) for receiving data to the data pages as designated by the respective users; a data send command (DSND) for transmitting data from the data pages as designated by the respective users; a copy search command (CFND) for searching the database for a user of which a copy is made by designating the requirement; a copy command (COPY) for combining and copying under permission by a user who meets the requirement of the copy search; a server search command (DIR) for writing the units of information meeting the information retrieval requirement in result pages; a list display command (LIST)) for looking through the result pages; an activity registration/modification/deletion command (MAKE) for generating, modifying and/or deleting an activity control program; a program execution command (AUTO) for executing an activity control program as registered; a data bind command (BIND) for binding the information of the page as designated to the work page; a data clear command (CLEAR) for clearing the data in the work page; a data delete command (DEL) for deleting the data stored in the disk storage device; a data edit command (EDIT) for editing the data in the work page; a format command (FORMAT) for setting the format of the data as registered; a schedule table generation command (REP) for generating a schedule table in which is written the activity of the server 2; a header generation command (HEAD) for generating a header table in which are written the headers of the activity of the server 2; a work page make command (PMAKE) for making a new work page; a rename command (NAME) for renaming information and the activities; a default value setting command (OPTION) for setting default values which are initial values given to the server 2; a password setting/changing command (PASS) for setting/changing passwords; an activity record command (MEM) for recording the manual activities of users in activity record pages; a data read command (READ) for reading data from an external page to a work page; a data write command (WRITE) for writing data from a work page to an external page as designated; a data arrangement command (X) which is periodically executed for arranging data in an effective storing manner; and a help command (HLP) for putting questions relating to the manipulations of the server 2.

Also, after the registration of the client terminals 1, the control unit 24 serves to generate the user information file 31 in which is written correspondence information of the respective client terminals 1 to the addresses thereof, a user names and so forth.

Furthermore, the control unit 24 serves to perform a variety of tasks by reading the default program in which are written a number of available services provided for the client terminals 1 from the program files 33.

Still further, the control unit 24 serves to store the user activity history relating to the activities of each client terminal 1 in the user activity database 34 in order to maintain the user activities.

Then, the control unit 24 prepares a modified program by rewriting the default program stored in the program files 33, or updates the modified program, on the basis of the user activity history and the commands as input through the respective one of the client terminals 1.

At this time, when controlling the process relating to the respective client terminal 1 in accordance with the program preparation information provided from the agent unit 23, the control unit 24 judges whether or not the respective commands should be run with reference to the correlation between the user activity history stored in the user activity database 34 and the commands provided in the control library 32 as corresponding to each other by means of the corresponding agent unit 23. A stochastic variable is allocated to each command. A value of 0 to 1 is assigned to each stochastic variable in accordance with the user activity history of each client terminal 1. The control unit 24 judges whether or not each command is viable with reference to the stochastic variable. The control unit 24 does not execute a command if the stochastic variable thereof is “0” and does execute a command with a probability of 100% if the stochastic variable thereof is “1”. The stochastic variable is dynamically adjusted by a function which is defined for each command.

However, there may be some commands which are executed with a probability of 100% without the use of the function by the control unit 24. The information about the usage and the associated information of a command, for which a function is defined, is stored as data by the control unit 24 in the control library 32 and used to give parameters to the function when running. The functions of the respective command may be configured to be modified to take a new argument or configured to take a variable number of arguments. In this case, the control unit 24 serves to add a new argument for a function when it is appropriate.

For example, in the case where a program includes a command A1 stored in the control library 32, the control unit 24 executes the function F1 corresponding to the command A1, during the execution of the program, to obtain the stochastic variable corresponding to the command A1 and skips the command A1 when the stochastic variable of the command A1 is “0” while the command A1 is viable when the stochastic variable of the command A1 is not “0”.

Also, the control unit 24 may execute another command in place of the command A1 when the stochastic variable of the command A1 is larger than “0” but smaller than “1”.

Furthermore, while the control unit 24 serves to execute the function of each command included in the program which is run in order to obtain the stochastic variables of the respective commands as described above, it is also possible to sequentially obtain the stochastic variables of the respective commands in advance of running the program by executing the function of each command and judge whether or not each command should be executed in order to modify the entirety of the program on the basis of the judgment. By this configuration, it is possible to aggregately judge whether or not the respective commands should be executed by means of the control unit 24 and therefore possible to effectively execute the program to cope with various traffic loads and lessen processing loads on the server 2.

Furthermore, it is possible to execute the functions by means of the control unit 24 for calculating the stochastic variables and interchanging the order of the commands, add a new command or delete a command to update programs with a predetermined time interval while running another program or storing another modified program for each client terminal 1 in the program files 33. The predetermined time interval is to be such that the load on the server 2 is not substantially increased thereby. For example, the calculation is conducted once per ten minutes.

The commands of a modified program which is modified with the stochastic variable by means of the control unit 24 are subjects of the update operation using the next stochastic variable. Accordingly, it is possible to successively update the modified programs by means of the control unit 24 in order to generate modified programs which are used to perform desired tasks at the client terminals.

Furthermore, in the case when there is a command which is executed with a probability of 100% in the control library 32 and therefore the corresponding agent units 23 need not update the program making use of that command, the agent unit 23 corresponding to the client terminal 1 can be deleted. In contrast with this, in the case when there is a command which is executed with a probability of 0% and therefore the stochastic variable can deviate from 0%, the agent unit 23 corresponding to the client terminal 1 making use of that command is not deleted. However, depending on the functions corresponding to the respective commands, it may be the case to delete a unit of the agent units 23 if said unit of the agent units 23 has not been used for a long time or if the period of the contract (or agreement) has been expired and so forth.

Still further, it is possible for the control unit 24 to judge whether or not the respective commands not only by executing the functions corresponding to the respective commands but also by allocating a function to each program and executing the function. Meanwhile, the control unit 24 may execute the function corresponding to each program to calculate the stochastic variable automatically or in response to a request transferred from a client terminal 1.

Also, while the modified program is generated with reference to the user activity history of the client terminal 1, i.e., the past requests transferred from the client terminal 1 in accordance with the above described embodiment, it is also possible to make use of other information such as, for example, information transferred from other resources available in the Internet than information as directly transferred from the client terminal 1. Examples of information transferred from other resources available in the Internet than information as directly transferred from the client terminal 1 include the period of time, the date or the weather when the client terminal 1 is used. Such information can be used to judge whether or not the respective commands should be run with reference to the user activity history. [Exemplary Operations of the Control Unit 24]

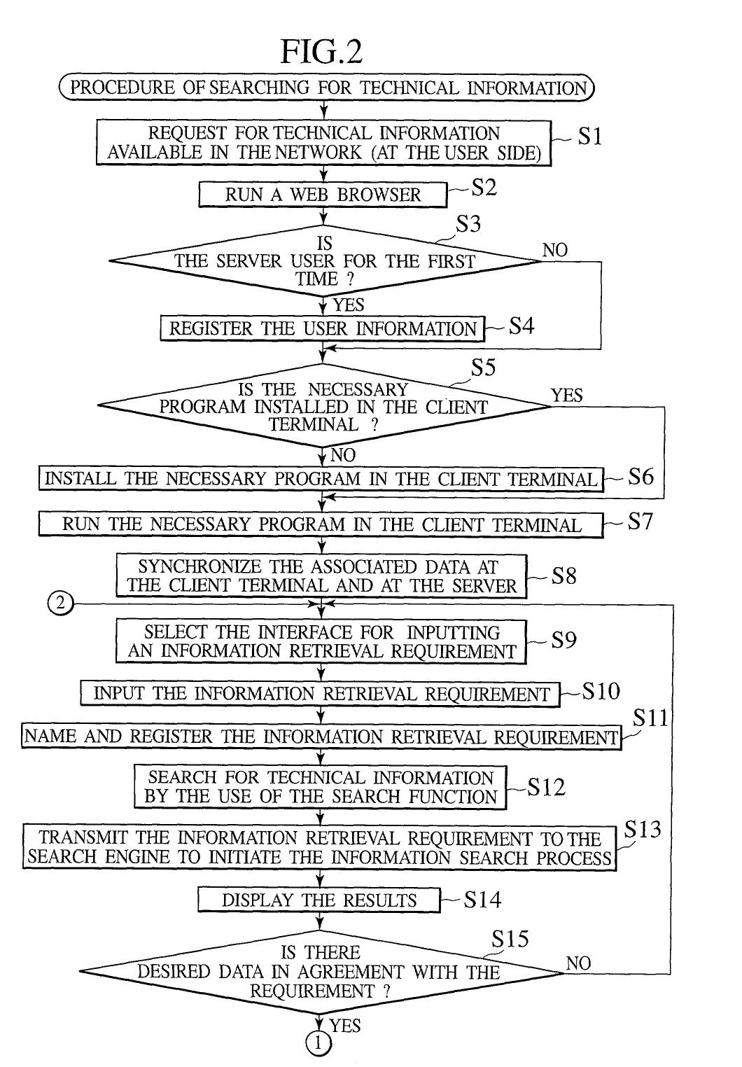

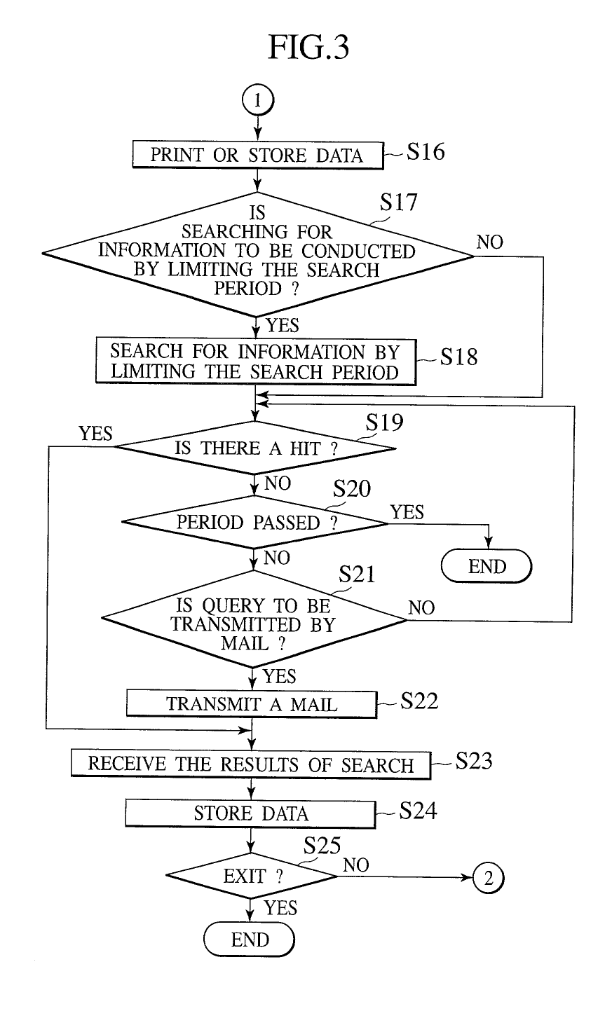

The control unit 24 serves to create a modified program by combining the control commands with the default program. In the following description, an exemplary procedure for creating a modified program will be explained with reference to FIG. 2 and FIG. 3.

First, as illustrated in FIG. 2, a client terminal 1 sends request for searching technical information available in the network 3 through the interface unit 21 in the step Si by running a WEB browser as stored in the client terminal 1 and accessing to the server 2 in the step S2.

Next, the control unit 24 serves to compare the user information file 31 with the information about the client terminal 1 accessing to the server 2, judge whether or not the server 2 is used by the client terminal 1 for the first time, and when the server 2 is used by the client terminal 1 for the first time, obtain the information about the client terminal 1 to register the information in the user information file 31 in the step S4. The control unit 24 serves to judge whether or not the necessary program for making use of the server 2 is installed in the client terminal 1 in the step S5, and if the program has not been installed yet, transfer the program to the client terminal 1 in order to install the program in the client terminal 1 in the step S6.

Next, the usability supporting evolutionary program is run at the server 2 and at the client terminal 1 in the step S7.

Next, the control unit 24 then synchronize the associated data at the server 2 with the corresponding data of the usability supporting evolutionary program at the client terminal 1 by receiving the results of searching from the agent unit 23 corresponding to the client terminal 1. By this configuration, the control unit 24 establishes association of the agent unit 23 with the client terminal 1 in the step S8.

Next, the interface for inputting an information retrieval requirement is selected at the client terminal 1 followed by transferring the information retrieval requirement to the server 2 in the step S9.

Next, the user of the client terminal 1 inputs the information retrieval requirement for searching technical information and transfer it to the server 2 in the step S10.

Next, the information retrieval requirement as received for searching for the technical information is named and registered by the control unit 24 in the step S11. In this case, the agent unit 23 serves to register the information retrieval requirement in the user activity history corresponding to a user information. By this configuration, different user information items are generated for the respective users by the agent units 23.

Next, the control unit 24 searches for the technical information by executing the default program or one of the modified programs which are different for different users in accordance with the registration condition in the step S12. At this time, the corresponding agent unit 23 serves to designate one of the modified program corresponding to the current user. When the user of the client terminal 1 decides the technical information as the information retrieval requirement, the information retrieval requirement is transmitted to the server 2 to initiate the information search process in the step S13.

Next, when the results of searching are obtained, the control unit 24 transmits the results of searching to the client terminal 1 in which the results of searching are displayed in the step S14.

Next, it is judged by the user of the client terminal whether or not the results of searching include a unit of information as desired in the step S15. If no desired information unit exists, the control is returned to the step S9 repeating the subsequent steps. If a desired information unit exists, the control is advanced to the step S16 as illustrated in FIG. 3.

Next, the unit of information as matched with the information retrieval requirement is printed or stored at the client terminal 1 in the step S16. A query is then provided by the server 2 about whether or not the information search process is to be conducted by limiting the search period in the step S17. When a search period is given as a new information retrieval requirement, the information search process is performed in the step S18, followed by judging whether or not a result of searching is obtained in the step S19.

Next, the control unit 24 serves to judge whether or not the period of searching the data as the subject of the search process is passed in the step S20. If passed, the process is terminated. If not passed, a query is provided by the server 2 about whether or not searching is to be continued with a new information retrieval requirement. If searching is to be continued with a new information retrieval requirement, the control is returned to the step S19 to repeat searching within the period. If searching is not continued, a query about usage of the information retrieval requirement may be posted by the e-mail service in the step S22. At this time, the control unit 24 serves to transfer an e-mail by the use of a mail address stored in the user information file 31 in accordance with the protocol for receiving and sending mails.

Next, the control unit 24 obtains the results of searching as matched with the information retrieval requirement and transferrs them to the client terminal 1. The client terminal 1 then receives the results of searching from the server 2 in the step S23.

Next, the client terminal 1 stores the data as received in an internal memory in the step S24, judges whether or not the information search process is continued, and if continued the control is returned to in the step S9.

The control unit 24 as described above performs the information search process in the step S9 to the step S25 while the agent unit 23 serves to count the frequency of execution of each command in the respective steps to obtain the statistical probabilities of execution of the respective commands for the respective steps and register the statistical probabilities in the user activity database 34. When the control unit 24 generates a modified program, the agent unit 23 serves to generate program preparation information by the use of the frequency of executing each of the respective step with reference to the user activity history stored in the user activity database 34. By this configuration, it is possible to generate such a modified program as customized for each user at the server 2 so that a desired process is conducted at the client.

In this case, for example, the agent unit 23 serves to delete such a step as executed at a lower frequency than a predetermined frequency in order to update the modified program. Furthermore, more specifically speaking, in the case where the step S18 is not performed at all, for example, the agent unit 23 serves to generate the modified program from which is deleted part of the program relating to the step S18 in order to lessen the load on the control unit 24.

Furthermore, when a user desires to insert a new processing step into the default program, it is possible to modify the default program at the server 2 by reading a control command(s) from the control library 32 and insert it into any desired position of the default program.

Still further, it is also possible to generate a modified program at the server 2 by combination of different programs in accordance with a request from a user. At this time, the control unit 24 modifies the functions of the agent units 23 serving to handle different schema managing programs for the respective users by copying a new agent unit and combining it with other agent units 23.

Still further, the server 2 serves to generate an agent unit anew in order to associate new default program with a client terminal 1 in response to the request from a user. By this configuration, it is also possible to provide many services from the server 2 by a variety of programs for the client terminals 1.

Still further, it is possible at the server 2 to delete an agent unit corresponding to such a program as is not used in response to the request from a user. By this configuration, it is possible at the server 2 to lessen the load on the control unit 24.

As described above, programs are generated, modified and deleted in accordance with the user activity so that it is also possible to provide high quality and high availability services for users.

While the programs of searching for units of information have been explained in the case of the above described embodiment of the present invention, the present invention is applicable to other types of programs such as those for providing advices relating to technical information, for controlling purchase procedures, for explaining items for sale and so forth. Namely, in accordance with the embodiments of the present invention, the program files 33 include default programs which are provided in order to cope with all the fields as required when there are needed a variety of procedures which are quite different from each other such as in the cases for providing advices relating to technical information, for controlling purchase procedures, for explaining items for sale and so forth.

By this configuration, it is also possible to at the server 2 to perform appropriate procedures as desired by users and decrease the size of each program resulting in increasing the execution speed by generating a modified program customized for each user.

Next, the characteristics of the present invention will be explained with an example of manipulations of a World Wide Web browser for searching the Internet for units of information in order to make clear the differences between the case in accordance with the present invention and the exsiting cases. In the case of the embodiment in accordance with the present invention, programs are generated, modified and deleted in accordance with the user activity so that it is also possible to provide high quality and high availability services for users.

A value of 0 to 1 is assigned to each stochastic variable in accordance with the user activity history of each client terminal 1. The control unit 24 judges whether or not a command is viable with reference to the stochastic variable. The stochastic variable is dynamically adjusted by a function which is defined for each command.

In this case, the print command is selected among from a variety of commands to be described in greater detail. Even if a particular user is considered, the probability of selecting the print command on a WEB page as displayed in the WEB browser fluctuates depending upon the URL of the WEB page. However, in the case where the probability of selecting the print command is particularly high when the user opens the URL of a certain WEB page, the usability is significantly improved by automatically opening a dialog box to solicit input from the user about whether or not the print command is executed when the user opens such a WEB page.

In this case, a modified program is generated in which the command for opening the URL is followed by automatically opening the dialog box to solicit input from the user about whether or not the print command is executed. For example, there are contained an OK button and a CANCEL button in the dialog box to solicit input from the user whether or not the print command is executed. By this configuration, after opening the URL, the user can print the page almost involuntarily without consideration of how to print. On the other hand, if the OK button is always clicked in the dialog box, the program is modified in order to automatically open a dialog box containing only a CANCEL button, while initiating the printing operation without waiting the instruction by the user, in place of the dialog box to solicit input from the user whether or not the print command is executed. The printing operation may be started immediately or a predetermined time after opening the URL. In this case, the printing operation is halted when the user clicks the CANCEL button.

Next, the function of the agent unit will be explained in details. One agent unit is provided for each of the respective users, maintains the user activity history and serves to act in the place of that user as faithful as possible. Accordingly, the agent unit maintains a kind of database. There is provided in the database necessary information required for generating modified programs. Needless to say, a variety of implementations are possible for the database.

Also in this case, the agent unit serves to automatically generate an optimal program in response to the manipulations of the user which are registered in the database which in turn is referred to by the agent unit for use in providing appropriate information. An agent unit may be deleted depending on the frequency of using that agent unit and so forth. Accordingly, such a kind of agent unit has a lifetime and then can be called a “biological agent”.

Generally speaking, text data is a most representative information item for use in a database. In this case, for example, a character string as input to a search dialog box is registered in the database and the occurrence frequency thereof is used to weight the character string as a reference to the importance. Also, the text data contained in each web page as displayed by the user is registered in the database. Particularly, the text data contained in such a web page as printed, copied or stored by the user is considered to be important and therefore registered in the database with an enhanced weight to indicate an enhanced importance. The agent unit serves to act as an agent of the user with reference to the database.

As compared with the conventional technologies, the searching technology in accordance with the present invention has the following advantages. Namely, the existing search engines includes such an engine as compares the search term(s) with the respective web pages to extract relevant web pages having a correlation with the search term(s), and then analizes the link structure thereof in order to search the relevant web pages for particularly relevant pages which are given ranks of importance. In this case, the web pages with ranks of importance as the results of searching are averagely valuable for anyone. This conventional technique is effective in terms of searching absolutely valuable web pages. However, it is important in practice that the web page as provided by the search engine is valuable for the user who has conducted that search operation, rather than for any other person than the user.

Contrary to this, in accordance with the embodiment of the present invention, the database is designed separately for each user to constitute an agent unit of the user. Namely, a given search term(s) is compared with the respective web pages to extract relevant web pages having a correlation with the search term(s), and the relevant web pages as the results of searching are then compared with the database for the user who has conducted that search operation in order to extract such web pages as are valuable for that user with appropriate ranks of importance for that user.

Particularly, it is possible to realize a significant search engine by combining the embodiment of the present invention with the conventional search engine as described above. Namely, at first, a given search term(s) is compared with the respective web pages in the Internet to extract relevant web pages having a correlation with the search term(s) followed by analyzing the link structure thereof in order to search the relevant web pages for particularly relevant pages which are given ranks of importance. Thereafter, the ranks as given to the particularly relevant web pages are modified by evaluating the correlation between the respective web pages with the database for the user who has conducted that search operation in order to give higher ranks to the web pages which are probably valuable for that user. By this configuration, it is possible to display upfront the web pages which have remarkable correlations with the database. The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

For example, while the system in accordance with the present invention is implemented within a server in the case of the above described embodiment, it is also possible to implement the system within a client. In this case, the function of the agent unit is implemented as a local program in a client with the database of an agent unit for a user of the client or the databases of agent units for users of the client.

What is claimed is:

1. A program generation system comprising:
an interface unit which is configured to receive a request for a service from a client terminal through a network;
a storage unit in which are stored a default program and a plurality of command codes which are executed in response to the request for a service as input through the interface unit;
a control unit which is configured to modify the default program by the use of the command codes stored in the storage unit on the basis of the request for a service as given from the client terminal through the interface unit in order to generate a modified program, to execute the modified program and to output the result of the execution of the modified program to the client terminal through the interface unit.

2. The program generation system as claimed in claim 1 further comprising an agent unit provided separately for each client of the services for manageing the program generation system, wherein
the agent unit takes control of the program generation system in accordance with the request for a service from a user.

3. The program generation system as claimed in claim 2 further comprising a user information storage mechanism for storing the user information of each client, wherein
the agent unit is provided in association with the user information file.

4. The program generation system as claimed in claim 1 wherein the program generation system serves to modify the process of generating a modified program in accordance with a user activity history.

5. The program generation system as claimed in claim 1 wherein the program generation system judges whether or not the respective command codes should be run with reference to the correlation between a user activity history and the command codes provided in the storage unit.

6. The program generation system as claimed in claim 5 wherein command codes, stochastic variables indicative of the probability of executing the command codes and functions for adjusting the stochastic variables are stored in the storage unit, and wherein
the program generation system serves to calculate the stochastic variables by using the functions, judges whether or not the respective command codes should be run with reference to the stochastic variables as calculated and generate modified programs.

7. A network system in which are connected a server system and a client system manipulated by a user through a network, the network system comprising:
a client system which is configured to use a default program and a modified program stored in the server system in response to manipulations by the user;
an interface unit which is configured to receive a request for a service in accordance with manipulations by the user;
a storage unit in which are stored a default program and a plurality of command codes which are executed in response to the request for a service as input through the interface unit;
a program control unit which is configured to modify the default program by the use of the command codes stored in the storage unit on the basis of the request for a service as given from the client terminal through the interface unit in order to generate a modified program, to execute the modified program, and to output the result of the execution of the modified program to the client terminal through the interface unit; and
an operation unit which is configured to execute the modified program on the basis of the information as input through the interface unit and to output the result of the execution of the modified program to the client terminal through the interface unit.

8. The program generation system as claimed in claim 7 further comprising an agent unit provided separately for each client of the services for manageing the program generation system, wherein
the agent unit takes control of the program generation system in accordance with the request for a service from a user.

9. The program generation system as claimed in claim 7 further comprising a user information storage mechanism for storing the user information of each client, wherein
the agent unit is provided in association with the user information file.

10. The program generation system as claimed in claim 7 wherein the program generation system serves to modify the process of generating a modified program in accordance with a user activity history.

11. The program generation system as claimed in claim 7 wherein the program generation system judges whether or not the respective command codes should be run with reference to the correlation between a user activity history and the command codes provided in the storage unit.

12. The program generation system as claimed in claim 7 wherein command codes, stochastic variables indicative of the probability of executing the command codes and functions for adjusting the stochastic variables are stored in the storage unit, and wherein
the program generation system serves to calculate the stochastic variables by using the functions, judges whether or not the respective command codes should be run with reference to the stochastic variables as calculated and generate modified programs.

13. An agent system implemented within a computer for improving usability in making use of a service provided in the Internet, the agent system comprising:
a database organized for management of the history of the past activities of a user of the service;
a mechanism which serves to predict a next manipulation by the user with reference to the database and perform the next manipulation in place of the user.

14. The agent system as claimed in claim 13 wherein a dialog box is automatically opened to solicit input from the user whether or not the next manipulation should be performed in advance of actually performing the next manipulation.

15. The agent system as claimed in claim 13 wherein the mechanism immediately performs the next manipulation as predicted in place of the user without consent of the user.

16. The agent system as claimed in claim 15 wherein a dialog box is automatically opened to enable the user to cancel the next manipulation as predicted and performed by the mechanism.

13. An agent system implemented within a computer for searching the Internet for information, the agent system comprising:
a database organized for management of the history of text data as handled by a user of the computer;
a mechanism which serves to receive a search term from the user and extract information items having a correlation with the search term therefrom; and
a mechanism which serves to extract, from the information items, relevant information items having a correlation with the text data as handled by the user.

18. The agent system as claimed in claim 17 wherein the text data as handled by the user of the computer and registered in the database for management includes a search term which has been used by the user.

19. The agent system as claimed in claim 17 wherein the text data as handled by the user of the computer and registered in the database for management includes the text data of a web page which has been browsed by the user.

20. The agent system as claimed in claim 19 wherein the text data of a web page which has been browsed by the user and printed, copied or stored by the user is registered in the database with a higher importance than other web pages.
